(19) United States
(12) Patent Application Publication
(10) Pub. No.: US 2016/0157064 A1
(43) Pub. Date: Jun. 2, 2016

(54) METHOD AND NOTIFYING UNIT FOR PROVIDING A NOTIFICATION ABOUT AN EVENT

(71) Applicant: TELEFONAKTIEBOLAGET LM ERICSSON (PUBL), Stockholm (SE)

(72) Inventors: Marcus GÅRDMAN, Skärholmen (SE); Cristian NORLIN, Stockholm (SE); Marcus NYBERG, Hägersten (SE)

(21) Appl. No.: 14/897,171

(22) PCT Filed: Jun. 11, 2013
(86) PCT No.: PCT/EP2013/061987

§ 371 Date: Dec. 9, 2015

(51) Int. Cl. H04W 4/06; H04W 4/12; H04W 4/02; H04W 4/22

(52) U.S. Cl. CPC H04W 4/06; H04W 4/22; H04W 4/12; H04W 4/028; H04W 88/02

(57) ABSTRACT

A notification is provided to mobile terminals regarding an event that potentially affects persons located in the vicinity. A notifying unit obtains a location of the event and identifies a set of radio nodes of a mobile network which are located within an affected area around the obtained location of the event. The notifying unit then determines a group of mobile terminals handled by users potentially affected by the event and moving basically towards the location of the event, based on at least two latest connections each mobile terminal has made with at least two of the identified radio nodes. The notifying unit finally provides a notification about the event to each mobile terminal in the determined group of mobile terminals. Thereby, no notification will be sent in vain to mobile terminals not moving towards the event so their users are deemed not interested in such a notification.

### TECHNICAL FIELD

The present disclosure relates generally to a method and a notifying unit associated with a mobile network for wireless communication, for providing a notification to at least one mobile terminal regarding an event.

### BACKGROUND

When an event occurs that in some way might affect persons located in the vicinity of the event, it would be helpful if those persons could get notified about the event as fast as possible so that they are able to take precautions and preferably avoid it by not going near the event. Some examples of events that typically affect persons so that they better not get near include riots and accidents, e.g. a road accident, a gas explosion, a fire, etc., which typically require that people make way for emergency staff such as an ambulance, fire brigade, police, etc. to arrive promptly and deal with the event without intrusion or interfering of other persons that just happen to be there. It is also naturally of interest for the affected persons to avoid getting stuck in a crowd or a traffic jam, or getting subjected to danger, distress or inconvenience in any way due to the event.

The above examples are basically events that cannot be foreseen before they actually occur which also include various traffic disturbances which could give rise to lengthy car queues. Other examples of events that may potentially affect persons nearby include big concerts, major sport occasions, demonstrations and manifestations, roads being closed for maintenance work, etc., which are more predictable events known in beforehand. In this disclosure, the term “event” is used to represent any event that can potentially affect persons located in the vicinity of the event, including any unpredictable or predictable occasions, such that it is of interest for those persons to be made aware of the event.

Today, there are known solutions for broadcasting spoken messages about traffic jams, road work and accidents and the like over a public radio channel, and also for broadcasting such messages only in a limited area, to be heard by car drivers provided they have their radio receiver switched on. Another possibility is to push notifications in a Short Message Service, SMS, message from a mobile network to all mobile terminals currently present within a certain distance from the location of an event. This is possible since the mobile network serving the mobile terminals normally has knowledge about the presence and whereabouts of its subscribers, at least on a cell level. Some positioning technique may also be used for locating the mobile terminals more accurately, e.g. using the Global Positioning System, GPS, technology or triangulation calculations on uplink signals received by multiple radio nodes in the mobile network.

However, there are some problems associated with the above known solutions. Firstly, in the case of broadcasting spoken messages over a public radio channel, it is of course necessary that the radio receiver is switched on and listened to, which is far from always the case. Consequently, all persons in the area not hearing the broadcast from a radio receiver will of course not get the message. Secondly, in the case of pushing notifications in SMS to mobile terminal users, a relatively large area around the event should be covered to make sure that any user that might get close enough to the event location is notified. As a result, a large quantity of users present in the area but without being affected by the event will get the SMS notification anyway, which can be quite disturbing for those users, particularly if there are many such notifications being frequently pushed out for various events, also generating a lot of traffic and processing in the network to frequently launch numerous SMS notifications particularly in areas with many users present.

Thirdly, it may be problematic and resource-demanding to obtain the current position of each mobile terminal in order to decide whether it is within a certain distance and should receive the SMS notification or not. Even though many modern mobile terminals of today are equipped with GPS functionality, this would require the terminals to frequently report their current position to a notification service or the like which consumes both battery in the terminal and resources in the network. Further, some mobile terminals within the distance may be located where it is not possible to receive a GPS signal. There are also many less advanced mobile terminals still in use that lack GPS or other positioning functionality, particularly in developing countries with poor population.

### SUMMARY

It is an object of embodiments described herein to address at least some of the problems and issues outlined above. It is possible to achieve this object and others by using a method and a notifying unit as defined in the attached independent claims.

According to one aspect, a method is performed by a notifying unit associated with a mobile network for wireless communication, for providing a notification to mobile terminals regarding an event that potentially affects persons located in the vicinity of the event. In this method, the notifying unit obtains a location of the event and identifies a set of radio nodes of the mobile network which are located within an affected area around the obtained location of the event. The notifying unit then determines a group of mobile terminals handled by users potentially affected by the event and moving basically towards the location of the event, based on at least two latest connections each mobile terminal has made with at least two of the identified radio nodes. The notifying unit finally provides a notification about the event to each mobile terminal in the determined group of mobile terminals.

According to another aspect, a notifying unit associated with a mobile network for wireless communication is configured to provide a notification to mobile terminals regarding an event that potentially affects persons located in the vicinity of the event. The notifying unit comprises an obtaining unit configured to obtain a location of the event, and a logic unit which is configured to identify a set of radio nodes of the mobile network which are located within an affected area around the obtained location of the event. The logic unit is also configured to determine a group of mobile terminals handled by users potentially affected by the event and moving basically towards the location of the event, based on at least two latest connections each mobile terminal has made with at least two of the identified radio nodes. The notifying unit also comprises a providing unit which is configured to provide a notification about the event to each mobile terminal in the determined group of mobile terminals.

Thereby, a notification about the event is warranted and may be helpful for the terminal users moving towards the event because it will enable the terminal users to avoid the event by deciding to move away from it instead or wait or take other precautions. No notification will be sent in vain to mobile terminals not moving towards the event such that their users are deemed to be unaffected by the event and thus not interested in reading such a notification. This will also limit the amount of sent notifications and the resulting load on the network caused by the notifications.

The above method and notifying unit may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 is a communication scenario illustrating how mobile terminals potentially affected by an event can be determined, according to some possible embodiments.

FIG. 2 is a flow chart illustrating a procedure in a notifying unit, according to further possible embodiments.

FIG. 3 is another communication scenario illustrating how mobile terminals potentially affected by an event can be determined, according to further possible embodiments.

FIG. 4 is a diagram illustrating an example of a procedure when the solution is used, according to further possible embodiments.

FIG. 5 is a block diagram illustrating a notifying unit in more detail, according to further possible embodiments.

### DETAILED DESCRIPTION

Briefly described, a solution is presented where a notification about an event is sent only to mobile terminals which are deemed to be affected by the event while no such notification is sent to other mobile terminals. Thereby, the amount of unnecessary notifications to unaffected users can be limited while ensuring that users likely to be affected will be made aware of the event, which would thus also limit usage of resources in the network for sending out the notification.

In this solution, it is recognized that it can be determined whether a mobile terminal user is likely to be affected by an event or not based on the mobile terminal's latest connections with at least one radio node of a mobile network serving the mobile terminal. For example, if the mobile terminal has been connected to a sequence of at least two radio nodes, e.g. by making handovers in active mode or cell re-selections in standby mode, which indicates that the mobile terminal is moving in a direction basically getting closer to the location of the event, it can be assumed that the mobile terminal user is or will likely be close enough to be affected by the event to some degree. In that case, a notification about the event is warranted because it will enable the user to avoid the event by moving away from it instead or take other precautions.

On the other hand, if the mobile terminal has been connected to a sequence of radio nodes which indicates that it is moving away from or at least not basically towards the location of the event, it can be assumed that the mobile terminal user will not be affected and a notification is therefore not warranted for this particular user. In this way, any uninteresting and disturbing notifications can be avoided to users deemed to be unaffected by the event which will also relieve the network from excessive and undue messaging to no avail.

The decision to send a notification or not to a mobile terminal may still be made even if the mobile terminal has not changed its connection lately from one radio node to another, presumably remaining still at one location if that location, which can be estimated by the current connection, is clearly close to or clearly far away from the location of the event. Thus, if the currently connected radio node is sufficiently close to the event, a notification could be sent to the mobile terminal, which is an added feature that may be used in conjunction with this solution.

The solution outlined above may be implemented by functionality in a notifying unit associated with a mobile network for wireless communication. The term “notifying unit” will be consistently used throughout this disclosure although other similar terms could be used as well. In practice, the notifying unit may be implemented in one or more nodes of the mobile network, e.g. in a suitable network management node such as a Mobility Management Entity, MME, or other corresponding core control node which normally handles various information about mobile terminals and users in the mobile network which information is typically held in a database such as a Home Location Register, HLR, or a Home Subscription Service, HSS. However, the solution is not limited in this regard and the notifying unit described herein could be implemented in any suitable node(s) external to or part of the mobile network. In particular, the notifying unit is able to retrieve information about mobile terminals' latest connections to radio nodes from the HLR or HSS, depending on the implementation and optionally also other terminal-specific information, which will be explained later below.

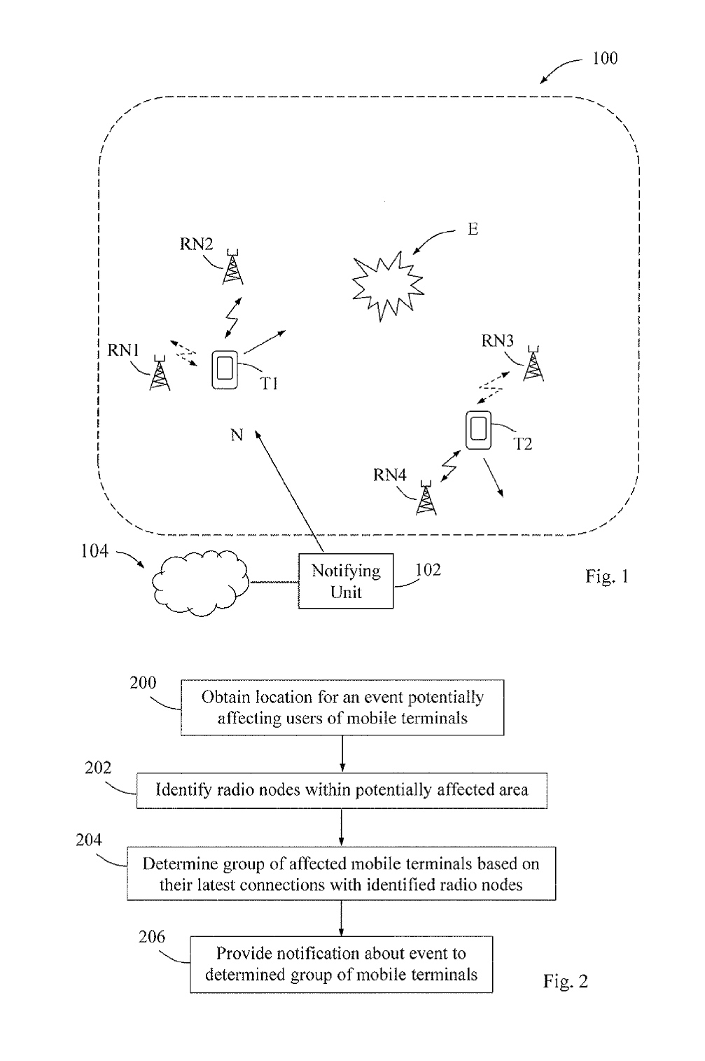

FIG. 1 illustrates a simplified example of how the solution may be used when an event “E” occurs somewhere that potentially affects users of mobile terminals if they would get near the location of the event, which could e.g. be any of the events exemplified above. When the geographic location of the event is known, an “affected area” 100 around the event location may be determined to limit the amount of radio nodes and mobile terminals that are to be considered for evaluation and decision of whether a notification should be sent or not.

The logic and actions outlined in this example are performed by a notifying unit 102 which is associated with a schematically illustrated mobile network 104. Throughout this disclosure, a radio node is a node in a mobile network to which node mobile terminals can be connected and communicate radio signals with in uplink and/or downlink, when the mobile terminals are either in active mode or standby mode. The term “radio node” thus represents any base station, NodeB, evolved NodeB, etc., depending on the terminology used, which is capable of radio communication with mobile terminals.

The affected area 100 should preferably be determined such that it can be assumed that any mobile terminal users present within the affected area might potentially be interested in getting a notification about the event, depending on whether they move basically towards the event location or not. In a possible embodiment, the affected area 100, i.e. its size and form, may be determined by analysing the impact of the event based on information about the nature of the event. The affected area 100 may be determined further based on an infrastructure around the event location, e.g. in the form of roads and streets as well as routes for public transport means such as trains and busses. For example, a major demonstration might warrant a larger affected area than a small road being closed. In another example, the affected area would typically extend longer along a major road with high speed traffic than along a walking path, and so forth.

Further, a set of radio nodes of the mobile network 104 are also identified which are located within the affected area. In this example, four network nodes RN1-RN4 are shown which have been identified as being located within the affected area 100, A group of mobile terminals handled by users potentially affected by the event and moving basically towards the location of the event, is then determined based on at least two latest connections each mobile terminal has made with at least two of the identified radio nodes. In another possible embodiment, the group of mobile terminals is determined from a plurality of mobile terminals which are identified as being located within the affected area.

In this simplified example, two mobile terminals T1 and T2 are shown which are found to be located within the affected area 100. Further mobile terminals may be present in the affected area 100, although not shown here. The mobile terminal T1 is moving basically towards the location of the event. This can be detected by checking which latest connections the mobile terminal T1 has had with at least two of the radio nodes within the affected area. In this case, terminal T1 has previously been connected to the radio node RN1 and is currently connected to the radio node RN2 which is closer to the event location than RN1, which implies that the mobile terminal T1 is moving basically towards the event location. Therefore, it is decided, by the notification unit 102, that a notification N about the event should be sent to mobile terminal T1.

On the other hand, mobile terminal T2 has previously been connected to the radio node RN3 and is currently connected to the radio node RN4 which is farther away from the event location than RN3, thus implying that the mobile terminal T2 is moving basically away from the event location. Therefore, it is decided that no notification about the event should be sent to mobile terminal T2 since its user is not deemed to be interested in such information.

However, it may not be necessary that the currently connected radio node is closer to the event location than the previously connected radio node to warrant a notification. This might be the case e.g. if some radio nodes are located to cover a travelling path which eventually leads towards the event location even if two successive recently connected radio nodes along that travelling path temporarily lead away from the event location.

In a possible option of implementing the solution, the set of radio nodes may be identified by: 1) analysing an infrastructure within the affected area, 2) identifying travelling paths of the infrastructure along which the mobile terminal users are able to move, and 3) identifying which radio nodes that provide radio coverage along those travelling paths. Identifying the set of radio nodes may further include: 4) identifying sequences of radio nodes along at least some of the identified travelling paths. This may be realized and saved in the form of a plurality of lists with successive radio nodes along different travelling paths. The group of mobile terminals may then be determined by matching the latest radio node connections of each mobile terminal with the identified sequences, or lists, of radio nodes. Further, the group of mobile terminals may be determined by determining that the mobile terminals in the group have moved closer to the location of the event along at least one of the identified travelling paths.

In the example shown in FIG. 1, both mobile terminals T1 and T2 were connected to just two successive radio nodes RN1-RN2 and RN3-RN4, respectively. However, any number of latest connected radio nodes more than one may be analyzed in the above-described manner for determining if a mobile terminal moves basically towards or away from the event location, in order to take a decision as to whether a notification should be sent to the mobile terminal or not. The solution is thus not limited in this respect. Further, the group of mobile terminals qualified to get the notification according to the above mechanism may include any number of terminals, including just one terminal, and the solution is not limited in this respect either.

An example of how the notifying unit in this disclosure may operate when using the solution, will now be described with reference to the flow chart in FIG. 2. The notifying unit is associated with a mobile network for wireless communication, and FIG. 2 illustrates a procedure performed by the notifying unit for providing a notification to mobile terminals regarding an event that potentially affects persons located in the vicinity of the event. This procedure may be performed by any of the notifying units 102, 300 and 400 described in this disclosure.

In a first shown action 200, the notifying unit obtains a location of the event. In this action, the event location and possibly other information about the event as well, may be obtained in different ways, e.g. including one or more of the following non-limiting examples:
1) A manually generated report of the event may be received from a person having noticed the event, either by first-hand observation or by knowledge in other ways.
2) An automatically generated report of the event may be received from an alarm system or similar. For example, a fire may first be noticed and reported by a person or by a fire detection device to a fire alarm system which then automatically sends information about the event to the notifying unit.
3) One or more sources of data pertaining to the event may be analyzed by the notifying unit, e.g. using a data mining functionality or the like. The sources of data may, without limitation, include some Internet-based social network such as Facebook or Twitter, or some public enterprise that publishes information about any observed events or forthcoming events known in beforehand such as road works, concerts, sport events, and so forth.

Any of the above examples of obtaining information about the event and others may be used alone or in combination, and the solution is not limited in this respect.

In a next action 202, the notifying unit identifies a set of radio nodes of the mobile network which are located within an affected area around the obtained location of the event. Some examples of how the affected area may be determined, e.g. by analysing the impact of the event based on information about the nature of the event and/or by analysing an infrastructure around the event location, have been described above.

In a further action 204, the notifying unit determines a group of mobile terminals handled by users potentially affected by the event and moving basically towards the location of the event. In this action, this group of mobile terminals is determined based on at least two latest connections of each mobile terminal with at least two of the identified radio nodes. The at least two latest connections are indicative of whether the evaluated mobile terminal is moving basically towards the location of the event or not. An example of this was described for FIG. 1 where the mobile terminal T1 was identified as moving towards the event E based on the terminal's latest connections previously with radio node RN1 and currently with RN2. Mobile terminal T1 would therefore in this action 204 be included in the group of mobile terminals with users potentially affected by the event and moving basically towards the location of the event.

As also mentioned in the above example of FIG. 1, identifying the set of radio nodes in action 202 may include analysing an infrastructure within the certain affected area, identifying travelling paths of the infrastructure along which the mobile terminal users are able to move, and identifying which radio nodes that provide radio coverage along the identified travelling paths. Then, identifying the set of radio nodes may further include identifying sequences of radio nodes along at least some of the travelling paths. Thereby, the group of mobile terminals may be determined by matching the latest connections of each mobile terminal with the identified sequences of radio nodes. As indicated above, a mobile terminal may be included in the group of mobile terminals when determining that the mobile terminal has moved closer to the location of the event along at least one of the identified travelling paths.

In a final shown action 206, the notifying unit provides a notification about the event to each mobile terminal in the determined group of mobile terminals. In practice, the notifying unit may provide the notification by triggering the mobile network to transmit the notification in a suitable message over the radio interface to each respective mobile terminal from a radio node which the mobile terminal is currently connected to.

In some exemplifying but non-limiting possible embodiments, the notification may be provided to each terminal in the group in a suitable message such as any of: a Short Message Service, SMS, message, a Multimedia Message Service, MMS, message, and a spoken message. In another possible embodiment, the notification may comprise information about at least one of: the location of the event, the nature of the event, such as “fire”, “road accident”, “demonstration”, etc., and an expected duration of the event. Thereby, the users of the notified mobile terminals will be enabled to better assess whether he/she should take precautions or not, e.g. by avoiding to come close to the event, or by waiting a while until the impact of the event is deemed to be non-disturbing for the user, and so forth.

Further, the notification provided to a specific mobile terminal in the group may comprise terminal-specific content adapted to the conditions of that mobile terminal and/or its user, which conditions may include at least one of: current location, current moving direction and current moving speed of the specific mobile terminal. For example, the terminal-specific content may comprise suggestions of alternative travelling routes that avoid the event, which could be helpful to the terminal user particularly when lacking knowledge of such travelling routes and the environment in general. Alternatively or additionally, the terminal-specific content may comprise an estimation of how far the respective terminal is from the location of the event, e.g. in terms of distance or time or both, and possibly a suggestion to stop and wait or reduce the travelling speed enough to avoid the expected impact of the event, and so forth.

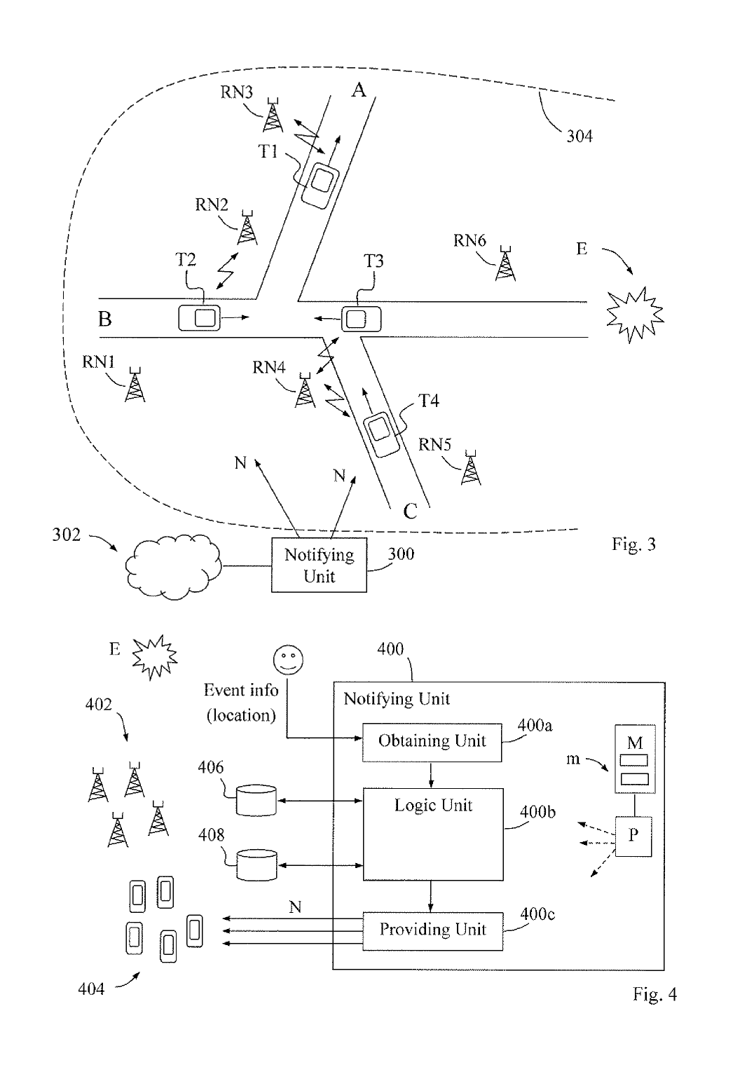

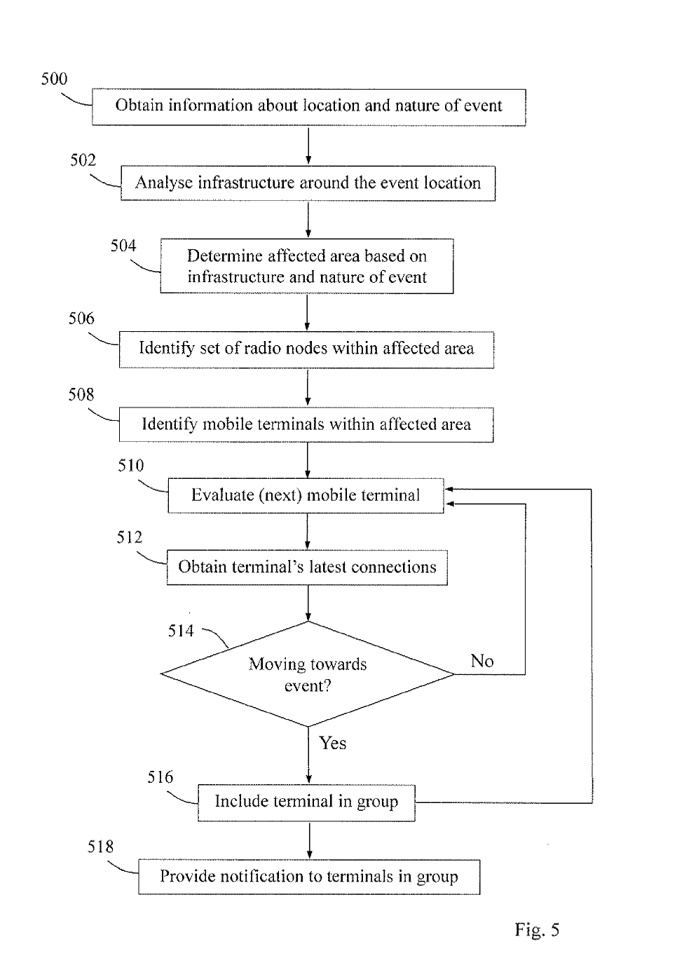

Another example of how the solution may be used in practice is illustrated in the scenario of FIG. 3 comprising an infrastructure of roads on which various mobile terminals T1-T4 travel in different directions. The following logic of actions is accomplished by a notifying unit 300 associated with a schematically illustrated mobile network 302. It is assumed that the location of the event has been obtained and that an affected area 304 around the event location has been determined, e.g. in the manner described above for the previous examples. It is further assumed that a set of radio nodes RN1-RN6 has been identified in the mobile network 302, e.g. as in action 202 above, which radio nodes are located within the affected area. A set of travelling paths along the shown roads has also been identified based on an infrastructure including these roads, as described above. The mobile terminals T1-T4 have been determined to be presently located within the affected area. The terminals T1-T4 will now be evaluated, one by one, by the notification unit 300 for possible inclusion in a group of mobile terminals to receive a notification N about the event, by determining whether they are moving basically towards the location of the event or not, as follows.

A first terminal T1 is determined to move basically away from the event location by detecting that the terminal T1 has changed its latest connections from RN2 to RN3 which implies that it travels along a road “A” covered by RN2 to RN3 away from the event, as shown in the figure. Therefore, terminal T1 is not included in the group of mobile terminals. Next, a second terminal T2 is determined to move basically towards the event location by detecting that the terminal T2 has changed its latest connections from RN1 to RN2 which implies that it travels along a road “B” covered by RN1 to RN2 towards the event, as shown in the figure. Therefore, terminal T2 is included in the group of mobile terminals.

The next evaluated terminal T3 is determined to move basically away from the event location by detecting that the terminal T3 has changed its latest connections from RN6 to RN4 which implies that it travels along the road “B” covered by RN6 to RN4 away from the event, as shown in the figure. Therefore, terminal T3 is not included in the group of mobile terminals.

It is then detected that a fourth terminal T4 has changed its latest connections from RN5 to RN4 which implies that it travels along the road “C” covered by RN5 to RN4, as shown in the figure. Even though this terminal T4 is actually moving more or less away from the event location when travelling along road C in the direction shown, analysis of the infrastructure including roads C and B implies that terminal T4 may turn right when reaching the road B and would thereby start moving towards the event instead. Therefore, terminal T4 is included in the group of mobile terminals since its user may potentially become affected by the event and would in that case be interested and helped by getting the notification. As a result, the notifying unit 300 sends a notification N to terminals T2 and T4 since they were included in the group of mobile terminals, but not to terminals T1 and T3 which were not included in the group of mobile terminals.

The scenario shown in FIG. 3 is a simplified illustration of some examples of how this solution may be applied for some mobile terminals. In reality, the infrastructure is typically more complex with numerous roads and streets and possibly also public transport routes which may be populated by a large number of mobile terminal users. By detecting and analyzing them one by one in the manner described above, the number of mobile terminals to which the notification about the event is provided can be significantly reduced, as compared to providing the notification to all mobile terminals found in the affected area without further analysis.

A detailed but non-limiting example of how a notification unit associated with a mobile network for wireless communication, may be structured with some possible functional units to bring about the above-described operation of the notification unit, is illustrated by the block diagram in FIG. 4. In this figure, the notification unit 400 is configured to provide a notification to mobile terminals regarding an event E that potentially affects persons located in the vicinity of the event. The notification unit 400 may be configured to operate according to any of the examples and embodiments described above and as follows. The notification unit 400 will now be described in terms of some possible examples of employing the solution.

The notification unit 400 comprises an obtaining unit 400a configured to obtain a location of the event E, basically as described above for action 200. The notification unit 400 further comprises a logic unit 400b configured to identify a set of radio nodes 402 of the mobile network which are located within an affected area around the obtained location of the event, basically as described above for action 202. The set of radio nodes 402 may be identified by retrieving information about the structure and/or topology of the mobile network from a database 406 holding such information. The database 406 may be maintained by a network management function or the like, depending on the network implementation.

The logic unit 400b is also configured to determine a group of mobile terminals 404 handled by users potentially affected by the event and moving basically towards the location of the event, based on at least two latest connections each mobile terminal has made with at least two of the identified radio nodes 402, basically as described above for action 204. The group of mobile terminals 404 may be determined by retrieving data about the mobile terminals and their latest connections from another database 408 holding such information. For example, the database 408 may be an HLR or HSS node, depending on the network implementation. The notification unit 400 also comprises a providing unit 400c configured to provide a notification “N” about the event to each mobile terminal in the determined group of mobile terminals 404, basically as described above for action 206.

The above notification unit 400 and its functional units 400a-c may be configured or adapted to operate according to various optional embodiments. In a possible embodiment, the logic unit 400b may be configured to determine the affected area by analysing the impact of the event based on information about the nature of the event and/or by analysing an infrastructure around the event location.

Further, the logic unit 400b may be configured to determine the group of mobile terminals from a plurality of mobile terminals which are located within the affected area. In further possible embodiments, the logic unit 400b may be configured to identify the set of radio nodes by analysing an infrastructure within the certain affected area, identifying travelling paths of the infrastructure along which the mobile terminal users are able to move, and identifying which radio nodes that provide radio coverage along the travelling paths. In that case, the logic unit 400b may be configured to identify the set of radio nodes by further identifying sequences of radio nodes along at least some of the travelling paths, and to determine the group of mobile terminals by matching the latest connections of each mobile terminal with the identified sequences of radio nodes. The logic unit 400b may further be configured to determine the group of mobile terminals by determining that each mobile terminal in the group has moved closer to the location of the event along at least one of the identified travelling paths.

The notification N may comprise information about at least one of: the location of the event, the nature of the event and an expected duration of the event. Furthermore, the notification provided to a specific mobile terminal in the group may comprise terminal-specific content adapted to at least one of: current location, current moving direction and current moving speed of the specific mobile terminal.

In further possible embodiments, the providing unit 400c may be configured to provide the notification in any of: a Short Message Service, SMS, message, a Multimedia Message Service, MMS, message, and a spoken message, although the solution is not limited to these exemplifying alternatives. Still further, the obtaining unit 400a may be configured to obtain the location of the event by at least one of: receiving a manually generated report of the event from a person, receiving an automatically generated report of the event from an alarm system, and analysing one or more sources of data pertaining to the event, which alternatives have been discussed above in the context of action 200.

It should be noted that FIG. 4 illustrates various functional units in the notification unit 400 and the skilled person is able to implement these functional units in practice using suitable software and hardware. Thus, the solution is generally not limited to the shown structures of the notification unit 400, and the functional units 400a-c may be configured to operate according to any of the features described in this disclosure, where appropriate.

The functional units 400a-c described above can be implemented in the notification unit 400 by means of program modules of a respective computer program comprising code means which, when run by a processor “P” causes the notification unit 400 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the notification unit 400 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the notification unit 400.

A more detailed example of how the above-described notification unit, e.g. 102, 300 or 400, may operate when employing at least some of the embodiments described herein. Thus, it is assumed that the notification unit is associated with a mobile network for wireless communication, and is operable for providing a notification to mobile terminal users regarding an event that potentially affects persons located in the vicinity of the event. A first shown action 500 illustrates that the notification unit obtains information about the event including location and nature of the event, basically corresponding at least partly to action 200 above.

In a next action 502, the notification unit analyses the infrastructure around the event location, e.g. including identifying possible travelling paths such a roads, streets, public transport routes, and so forth. In a further action 504, the notification unit also determines an affected area around the event location by analyzing the impact of the event based on the above-obtained information about the nature of the event and the infrastructure. Actions 502 and 504 may be performed in any order or together since it may be helpful to determine the affected area and make the analysis of infrastructure within the affected area.

A next action 506 illustrates that the notification unit identifies a set of radio nodes located within the affected area, which may be done by retrieving network topology information from a database such as database 406 mentioned above, and optionally also identifying sequences of radio nodes along at least some of the travelling paths identified in action 502. In a next action 508, the notification unit identifies all mobile terminals currently present in the affected area.

The following actions illustrate how the mobile terminals identified in action 508 are evaluated one by one for deciding as to whether a notification about the event should be provided to the mobile terminals or not, which will result in a group of mobile terminals to which the notification is provided, basically corresponding at least partly to action 204 above. Thus, in an action 510, one of the identified mobile terminals is selected for evaluation and another action 512 illustrates that the notification unit obtains the selected mobile terminal's latest connections with two or more of the radio nodes identified in action 506, which may be done by retrieving connection information from a database such as database 408 mentioned above. The notification unit then determines in an action 512 whether the mobile terminal is moving towards the location of the event. If not, it is decided that the mobile terminal should not be included in the group of mobile terminals and the next mobile terminal is evaluated by returning to action 510.

On the other hand, if the notification unit determines in action 512 that the mobile terminal is moving towards the location of the event, that mobile terminal is included in the group of mobile terminals to which the notification should be provided, in an action 516. The process may then return to action 510 for evaluating the next mobile terminal. Actions 510-516, or at least actions 510-514 depending on the outcome of action 514, may then be repeated until all of the mobile terminals identified in action 508 have been evaluated accordingly.

Advantages that may be achieved by employing one or more of the above-described embodiments include the saving of resources in the network and the radio interface by not providing notifications about the event to all mobile terminals in the affected area but only to those deemed to be affected by the event by moving basically towards the location of the event. Another advantage is that the terminal users will get the notification only when it is deemed to be of interest while no notifications about other events are received. Thereby, the notification mechanism will be more effective and non-disturbing.

From a perspective of the terminal users, the above notification mechanism may be a service that can be subscribed to by registration of their terminals. When doing so, the user accepts that the service and network can store the user's identity as well as make use of stored information regarding which radio nodes the user has been connected to, In practice, each “handshake” between the registered terminal and the radio nodes in the operator's mobile network is stored—but only for a limited duration with consideration of privacy. The user does not have to use any particular adapted terminal as long as the device has a Subscriber Identity Module, SIM card or similar and is connected to the mobile operator's mobile network and at least can receive the notifications. The notifications may be delivered e.g. as SMS messages, MMS messages, voice messages, e-mails, etc., depending on the receiving mobile terminals' capabilities and/or preferences specified by the users. This means that the service may be realized in different ways in practice, e.g. anything ranging from a simple SMS service to a smartphone application, without limitation.

While the solution has been described with reference to specific exemplary embodiments, the description is generally only intended to illustrate the inventive concept and should not be taken as limiting the scope of the solution. For example, the terms “notifying unit”, “event”, “mobile terminal”, “radio node”, “notification” and “infrastructure” have been used throughout this description, although any other corresponding entities, functions, and/or parameters could also be used having the features and characteristics described here. The solution is defined by the appended claims.

1. A method performed by a hardware notifying unit associated with a mobile network for wireless communication, for providing a notification to mobile terminals regarding an event that potentially affects persons located in the vicinity of the event, the method comprising:
obtaining a location of the event,
identifying a set of radio nodes of the mobile network which are located within an affected area around the obtained location of the event,
determining a group of mobile terminals handled by users potentially affected by the event and moving basically towards the location of the event, based on at least two latest connections each mobile terminal has made with at least two of the identified radio nodes, and
providing a notification about the event to each mobile terminal in the determined group of mobile terminals.

2. A method according to claim 1, wherein the affected area is determined by analysing the impact of the event based on information about the nature of the event and/or by analysing an infrastructure around the event location.

3. A method according to claim 1, wherein the group of mobile terminals is determined from a plurality of mobile terminals which are located within the affected area.

4. A method according to claim 1, wherein identifying the set of radio nodes includes analysing an infrastructure within the certain affected area, identifying travelling paths of the infrastructure along which the mobile terminal users are able to move, and identifying which radio nodes that provide radio coverage along said travelling paths.

5. A method according to claim 4, wherein identifying the set of radio nodes further includes identifying sequences of radio nodes along at least some of the travelling paths, and the group of mobile terminals is determined by matching the latest connections of each mobile terminal with the identified sequences of radio nodes.

6-10. (canceled)

11. The hardware notifying unit associated with a mobile network for wireless communication, the notifying unit being configured to provide a notification to mobile terminals regarding an event that potentially affects persons located in the vicinity of the event, the notifying unit comprising:
a processor configured to:
obtain a location of the event,
identify a set of radio nodes of the mobile network which are located within an affected area around the obtained location of the event, and to determine a group of mobile terminals handled by users potentially affected by the event and moving basically towards the location of the event, based on at least two latest connections each mobile terminal has made with at least two of the identified radio nodes, and
provide a notification about the event to each mobile terminal in the determined group of mobile terminals.

12. The hardware notifying unit according to claim 11, wherein the processor is configured to determine the affected area by analysing the impact of the event based on information about the nature of the event and/or by analysing an infrastructure around the event location.

13. The hardware notifying unit according to claim 11, wherein the processor is configured to determine the group of mobile terminals from a plurality of mobile terminals which are located within the affected area.

14. The hardware notifying unit according to claim 11, wherein the processor is configured to identify the set of radio nodes by analysing an infrastructure within the certain affected area, identifying travelling paths of the infrastructure along which the mobile terminal users are able to move, and identifying which radio nodes that provide radio coverage along said travelling paths.

15. The hardware notifying unit according to claim 14, wherein the processor is configured to identify the set of radio nodes by further identifying sequences of radio nodes along at least some of the travelling paths, and to determine the group of mobile terminals by matching the latest connections of each mobile terminal with the identified sequences of radio nodes.

16. The hardware notifying unit according to claim 14, wherein the processor is configured to determine the group of mobile terminals by determining that each mobile terminal in the group has moved closer to the location of the event along at least one of the identified travelling paths.

17. The hardware notifying unit according to claim 11, wherein the notification comprises information about at least one of: the location of the event, the nature of the event and an expected duration of the event.

18. The hardware notifying unit according to claim 11, wherein the notification provided to a specific mobile terminal in the group comprises terminal-specific content adapted to at least one of: current location, current moving direction and current moving speed of the specific mobile terminal.

19. The hardware notifying unit according to claim 11, wherein the processor is configured to provide the notification in any of: a Short Message Service, SMS, message, a Multimedia Message Service, MMS, message, and a spoken message.

20. The hardware notifying unit according to claim 11, wherein the processor is configured to obtain the location of the event by at least one of: receiving a manually generated report of the event from a person, receiving an automatically generated report of the event from an alarm system, and analysing one or more sources of data pertaining to the event.
